(19) United States
(12) Patent Application Publication
(10) Pub. No.: US 2025/0013967 A1
(43) Pub. Date: Jan. 9, 2025

(54) METHOD FOR INSPECTING THE QUALITY OF A FASTENING OF AN ANCHOR OR MOUNTING RAIL

(71) Applicant: fischerwerke GmbH & Co. KG, Waldachtal (DE)

(72) Inventor: Lars FREUDIGMANN, Tübingen (DE)

(73) Assignee: fischerwerke GmbH & Co. KG, Waldachtal (DE)

(21) Appl. No.: 18/713,652

(22) PCT Filed: Dec. 2, 2022
(86) PCT No.: PCT/EP2022/084236

§ 371 Date: May 26, 2024

(30) Foreign Application Priority Data
Dec. 16, 2021 (DE) 10 2021 133 384.9

(51) Int. Cl. G06Q 10/0639; E04B 1/41; G06F 16/38; G06K 7/14

(52) U.S. Cl. CPC G06Q 10/06395; E04B 1/4107; G06F 16/381; G06K 7/1404

(57) ABSTRACT

Attaching QR codes or other identification codes to an anchor rail and to associated components such as hammerhead bolts and attachments and to check with the aid of, for example, a smartphone as an optoelectronic reader whether the components belong to the anchor rail.

The invention relates to a method for inspecting the quality of at least one quality criterion of a fastening of an anchor or mounting rail having the features of the preamble of claim 1.

“Inspecting the quality” means to determine whether a specific, defined and verifiable quality criterion is met when fastening an anchor or mounting rail and/or when fastening to an anchor or mounting rail.

Anchor and mounting rails serve to fasten attachments by means of hammerhead bolts, the hammerheads of which are, or are to be, positioned sideways in the anchor or mounting rail, or by means of so-called sliding nuts which are typically rectangular or diamond-shaped and are introduced into the anchor or mounting rail. An “anchor rail” is understood to mean a profile rail which is arranged so as to be recessed in an anchor base made of, in particular, concrete such that a visible side of the anchor rail is flush with a surface of the anchor base. The anchor rail typically has anchors which project from the anchor rail into the concrete from a base side of the anchor rail opposite the visible side and which anchor the anchor rail in the anchor base. Mounting rails are typically used for mounting supply and disposal lines and are placed so as to be, in particular, suspended under a ceiling of a building. Anchor and mounting rails are typically C-profile rails.

Patent EP 3 514 297 B1 discloses an anchor rail with holes in a transverse center of a base side of the anchor rail, in which holes anchors protruding outward from the anchor rail can be fastened. Holes that are not required are closed with plugs before concreting so that concrete does not flow into the anchor rail. The plugs have an identification with an identification code for the anchor rail.

The object of the invention is to propose a method for inspecting the quality of a fastening of an anchor or mounting rail.

The quality inspection relates to meeting one or more quality criteria of the fastening of, and/or to, the anchor and mounting rail, such as, for example, meeting required edge distances or anchoring depths of the anchor rail, and/or to using attachments associated with the anchor and mounting rail, component fasteners such as hammerhead bolts, sliding nuts or suspending brackets or other components associated with the anchor or mounting rail, and/or to correctly fastening these components to the anchor or mounting rail. “Associated components” are understood to mean components which are provided and/or approved for use with the anchor or mounting rail.

This object is achieved according to the invention via the features of claim 1. According to the invention, the anchor or mounting rail includes an optoelectronically readable identification code on a visible side. An optoelectronically readable identification code can be optically read and electronically evaluated or processed using a suitable reader. The code allows for a preferably unique identification of the anchor and mounting rail. For example, one-dimensional identification codes such as bar codes or two-dimensional identification codes such as QR codes are known and can be used. A use of three-dimensional, optoelectronically readable identification codes with holograms, for example, is also possible. The enumeration serves to exemplify optoelectronically readable identification codes that can be used for the method according to the invention. The enumeration is exemplary and not exhaustive.

A “visible side” is a side of the anchor or mounting rail that is visible after the anchor or mounting rail has been anchored or fastened as provided. Once the anchor or mounting rail has been anchored or fastened as provided, at least the identification code is accessible or visible such that it can be read with an optoelectronic reader. The anchor or mounting rail can have several visible sides. At least one identification code is attached to at least one visible side of the anchor rail or mounting rail.

According to the invention, the optoelectronically readable identification code of the anchor or mounting rail is read with the optoelectronic reader and evaluated in terms of at least one quality criterion, which is also detected optoelectronically. Thus, for example, an edge distance of an anchor rail anchored in an anchor base is measured with the optoelectronic reader and the optoelectronic identification code of the anchor rail is read. The optoelectronic reader determines a minimum distance of the anchor rail on the basis of the identification code and checks whether the minimum distance has been met. The edge distance is an example of a quality criterion that can be tested using the method according to the invention.

The invention allows for checking in an efficient and largely automated manner whether one or more quality criteria of a fastening of an anchor or mounting rail have been met.

One configuration of the invention provides for the anchor rail to have a measuring marker on its visible side, with the aid of which the optoelectronic reader detects and evaluates a position of the anchor rail in the anchor base when carrying out the method according to the invention. In that case, the detected and evaluated quality criterion is a position criterion, namely the edge distance of the anchor rail from an edge or also from two abutting edges of the anchor base in which the anchor rail is anchored. The measuring marker can be, for example, a line on the visible side of the anchor rail, with the aid of which the optoelectronic reader can detect the edge distance of the anchor rail from one or more edges of the anchor base in a longitudinal direction or transversely to the anchor rail. The anchor rail can have several measurement markers at defined distances which allow for determining the edge distance of the anchor rail from the edge or edges of the anchor base. The anchor rail can have a measurement marker independent of the identification code, or the identification code or components of the identification code can be used as a measurement marker of the anchor rail. Such components are, for example, lines of a barcode or edge marks or position marks of a QR code.

One configuration of the invention provides for components associated with the anchor or mounting rail to have an optoelectronically readable identification code as well. Said code is also detected with the optoelectronic reader and is evaluated to check whether the component belongs to the anchor or mounting rail. In this way, it can be determined whether one or more components arranged on or fastened to the anchor or mounting rail are associated with the anchor or mounting rail, or whether components have been arranged on or fastened to the anchor or mounting rail which are not intended for use with the anchor or mounting rail. Another or further quality criterion can be an end distance of the component from one end of the anchor or mounting rail. The optoelectronic reader checks, in particular, whether the hammerhead is positioned sideways in the anchor or mounting rail.

Applying optoelectronically readable identification codes and/or measurement markers at different locations of the anchor or mounting rail and/or at different locations of an associated component allows for detecting one or more of the identification codes even if other identification codes are covered. Applying optoelectronically readable measurement markers at different locations distributed evenly or unevenly over a length of the anchor rail allows for determining the edge distance transversely to the anchor rail at the different locations.

Another quality criterion that can be evaluated using the method according to the invention is an evaluation whether the component is arranged at or fastened to the anchor or mounting rail as intended. For example, a hammerhead bolt has a rotational position marker as a measuring marker, on the basis of which the electronic reader can optoelectronically detect an orientation of a hammerhead of the hammerhead bolt.

One configuration of the invention provides for the optoelectronic reader to be a smartphone or a tablet computer on which an app, i.e., an application software, is installed for checking and evaluating the identification codes of the anchor or mounting rail and optionally the components fastened thereto or arranged thereon, which app can be used to detect and check whether the quality criterion or criteria of the fastening of the anchor or mounting rail and, optionally, of the components fastened thereto has or have been met. Other optoelectronic readers are not excluded.

One configuration of the invention provides for a database in which the anchor or mounting rail or various anchor or mounting rails and components associated with the anchor or mounting rail(s), the associated identification codes, and various quality criteria are stored. With the aid of the database, the optoelectronic reader checks compliance with one or more quality criteria of the fastening of the anchor or mounting rail and optionally of one or more components arranged thereon or fastened thereto.

The features and feature combinations, embodiments, and designs of the invention as mentioned above in the description, as well as the features and feature combinations as mentioned below in the description of FIGURES and/or drawn in the FIGURE, are usable not only in the combination indicated or shown in each case; rather, in principle any other combinations are also usable, or said features can be used individually. Embodiments of the invention are possible which do not have all features of a dependent claim. Individual features of a claim can also be replaced by other disclosed features or feature combinations. Embodiments of the invention are possible which do not have all the features of the exemplary embodiment, but rather a fundamental arbitrary part of the features of the exemplary embodiment.

The invention is explained in more detail below using an exemplary embodiment illustrated in the drawing. The single FIGURE shows:

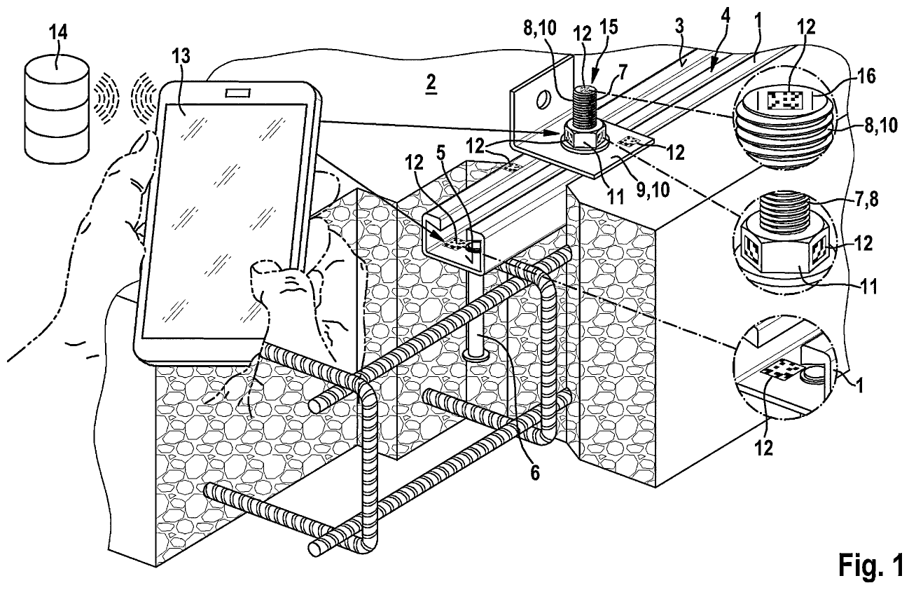

FIG. 1: A perspective, partially cut-out view of an anchor rail anchored in concrete for explaining the invention.

The anchor rail 1 shown in FIG. 1 is embedded in an anchor base 2 made of concrete in such a way that a side of the anchor rail 1, referred to herein as the visible side 3, is flush with a surface of the concrete or anchor base 2. In the exemplary embodiment, the anchor rail 1 is a C-profile rail with a continuous longitudinal slot 4 in the transverse center of the side referred to herein as the upper side 3. From a side of the anchor rail 1 opposite the upper side 3, which is referred to herein as the base side 5, anchors 6 protrude from the anchor rail 1 and project into the concrete to anchor the anchor rail 1 in the concrete forming the anchor base 2.

A hammerhead bolt 7 is mounted on the anchor rail 1 the hammerhead (not shown in the drawing) of which is introduced into the anchor rail 1 in a longitudinal direction of the anchor rail 1, aligned by the longitudinal slot 4 of the anchor rail 1, and is positioned sideways in the anchor rail 1 by a 90° rotation such that the hammerhead (not shown) engages behind the anchor rail 1.

The hammerhead bolt 7 forms a component fastener 15 which is provided for use with the anchor rail 1, namely for fastening an attachment 9 or another component 10 to the anchor rail 1. Therefore, the hammerhead bolt 7 can also be understood as a component 10 associated with the anchor rail 1. For example, a component 10 associated with the anchor rail 1 can be fastened to the anchor rail 1 also with a so-called sliding nut (not shown) instead of with the hammerhead bolt 7, which sliding nut is, or is to be, arranged in the anchor rail 1 instead of the hammerhead bolt 7. Such a sliding nut also forms a component fastener 15 and a component 10 associated with the anchor rail 1.

A metal bracket having a through-hole for the bolt shaft 8 to pass through is placed onto a bolt shaft 8 of the hammerhead bolt 7 which protrudes perpendicularly outward from the anchor rail 1. The metal bracket forms an attachment 9 of the anchor rail 1 and is referred to herein as a component 10 associated with the anchor rail 1. “Associated” means that a component 10 is provided for use with the anchor rail 1. In particular, a component 10 associated with the anchor rail 1 is provided to be arranged on or fastened to the anchor rail 1. The anchor rail 1 can have associated components 10 in addition to, and/or other than, the metal bracket and the hammerhead bolt 7, which are provided for use with, and in particular for arrangement on or fastening to, the anchor rail 1 (not shown).

A nut 11 is screwed onto the bolt shaft 8 and clamps the hammerhead (not shown) of the hammerhead bolt 7 from inside and the attachment 9 from outside against the anchor rail 1 to thus fix the hammerhead bolt 7 and the attachment 9 to the anchor rail 1. The nut 11 is also a component 10 associated with the anchor rail 1. A washer is arranged on the bolt shaft 8 of the hammerhead bolt 7 between the nut 11 and the attachment 9.

The anchor rail 1 includes data matrix codes (DMC codes), i.e., two-dimensional, optoelectronically readable identification codes 12, applied outside on the visible side 3 and inside on base side 5 of the anchor rail 1. The identification codes 12 are applied on the anchor rail 1 such as to be readable with an optoelectronic reader 13 when the anchor rail 1 is arranged so as to be recessed in the anchor base 2 as intended and shown in such a way that the visible side 3 of the anchor rail 1 is flush with the surface of the anchor base 2. Optoelectronically readable identification codes other than a DMC code are also possible, for example one-dimensional bar codes or, for example, holograms or other two- or three-dimensional identification codes (not shown).

The anchor rail 1 has several identical identification codes 12, which are applied evenly or unevenly over a length of the anchor rail 1 on the outside on the visible side 3 and on an inside of the base side 5 of the anchor rail 1 facing the visible side 3. In the exemplary embodiment, the identification codes 12 are applied on the anchor rail 1 at defined and equal distances from each other in a longitudinal direction of the anchor rail 1. Identification codes 12 closest to the ends of the anchor rail 1 are applied on the anchor rail 1 at a defined distance from the ends of the anchor rail 1. Due to the fact that several identification codes 12 are arranged so as to be distributed over the length on the visible side 3 and on the inside of their base side 5 of the anchor rail 1, several identification codes 12 of the anchor rail 1 are optoelectronically readable practically always, even if several identification codes 12 are covered by attachments 9 or other components 10.

Components 10 associated with the anchor rail 1 also have identification codes 12 which in the exemplary embodiment are also QR codes. The identification codes 12 are also applied on the associated components 10 at locations at which they are optoelectronically readable when the components 10 are arranged on or fastened to the anchor rail 1 as planned and when the anchor rail 1 is anchored so as to be recessed in the anchor base 2, with the visible side 3 of the anchor rail 1 being flush the surface of the anchor base 2 as intended. For example, the nut 11 has identification codes 12 on every other of its six key surfaces, and the hammerhead bolt 7 has an identification code 12 on an end face of its bolt shaft 8 remote from the hammerhead of the hammerhead bolt 7 (see detail enlargements).

In the exemplary embodiment, identical components 10 have identical identification codes 12 and different components 10 have different identification codes 12, wherein the identification codes 12 of the anchor rail 1 and the identification codes 12 of the components 10 are different as well. It is also possible for each component 10 to have an individual identification code 12.

A smartphone with which the identification codes 12 can be read optoelectronically and on which an app, i.e., a computer program, is stored, with the aid of which the identification codes 12 can be evaluated, is used as an optoelectronic reader 13. Instead of using a smartphone, it is also possible to use, for example, a tablet computer as an optoelectronic reader 13 (not shown). The optoelectronic reader 13 is in communication with a database 14 via mobile Internet, which database is shown in the drawing as a circuit symbol. The anchor rail 1 and further anchor rails and all components 10 associated with the various anchor rails 1, including their association with one or also several anchor rails 1, are stored in the database 14 such that the optoelectronic reader 13 can check whether or not the components 10 arranged on or fastened to the anchor rail 1 are associated with the anchor rail 1. The identification codes 12 associated with the various anchor rails 1 and the associated components 10, and the quality criteria of the fastening or anchoring of the anchor rail 1 in the anchor base 2 and of the arrangement or fastening of the components 10 associated with the anchor rail 1 to the anchor rail 1 are also stored in the database 14. Quality criteria of the fastening of the anchor rail 1 in the anchor base 2 is, in particular, a minimum edge distance of the anchor rail 1 from an edge of the anchor base 2 transversely to the anchor rail 1 that needs to be kept and a minimum edge distance of the ends of the anchor rail 1 from edges of the anchor base 2 in the longitudinal direction of the anchor rail 1.

According to the invention, after anchoring the anchor rail 1 in the anchor base 2 and arranging or fastening its associated components 10 to the anchor rail 1, the identification codes 12 of the anchor rail 1 and of all components 10 arranged thereon and fastened thereto are optoelectronically read with the reader 13, and whether the components 10 are associated with the anchor rail 1 is checked. It is also possible to check whether a component 10 belongs to the anchor rail 1 before the component 10 is arranged on or fastened to the anchor rail 1. Whether or not the components 10 belong to the anchor rail 1 is a quality criterion of the arrangement or fastening of the components 10 on the anchor rail 1.

Furthermore, according to the invention, at least one quality criterion or compliance with at least one quality criterion of the fastening of the anchor rail 1, i.e., in the exemplary embodiment anchoring of the anchor rail 1 in the anchor base 2, is checked. These quality criteria are, in particular, keeping the minimum edge distances of the anchor rail 1 from edges of the anchor base 2 transversely to the anchor rail 1 and in its longitudinal direction. Another quality criterion that can be checked is a parallelism of the anchor rail 1 to the one edge of the anchor base 2. The quality criteria or features of the quality criteria-namely, in the present case, the actual edge distances of the anchor rail 1 from the edges of the anchor base 2 and optionally the parallelism of the anchor rail 1 to the one edge of the anchor base 2—are also detected optoelectronically with the optoelectronic reader 13.

In order to be able to optoelectronically measure the edge distances of the anchor rail 1 from the edges of the anchor base 2, the anchor rail 1 has measurement markers on its visible side 3 and on the inside of its base side 5, with the aid of which a position of the anchor rail 1 can be detected optoelectronically. In the exemplary embodiment, the corners and edge lines of the DMC code are used for this purpose. When using a QR code, the position markers of the QR codes used as identification codes 12 are used as measurement markers which have QR codes at three of their four corners. However, in addition to the identification codes 12, special measurement markers can also be applied to the anchor rail 1 (not shown). Since the identification codes 12 having the measurement markers for optoelectronically detecting the position of the anchor rail 1 are applied to the anchor rail 1 at defined distances, the distance of the anchor rail 1 from the edges of the anchor base 2 can be calculated from the optoelectronically detected distance of the measurement markers of the anchor rail 1, and compliance with the minimum edge distances transversely to the anchor rail 1 and in the longitudinal direction of the anchor rail 1 as quality criteria of the fastening or anchoring of the anchor rail 1 can be determined.

The hammerhead bolt 7 has a rotational position marker 16 in addition to the identification code 12, with which the optoelectronic reader 13 can detect a rotational position of the hammerhead bolt 7. “Rotational position” means, in particular, whether the hammerhead of the hammerhead bolt 7 is arranged transversely to the anchor rail 1, i.e., engages behind the anchor rail 1, or not. When checking whether the hammerhead bolt 7 belongs to the anchor rail 1, the optoelectronic reader 13 also checks the rotational position of the hammerhead bolt 7 relative to the anchor rail 1 on the basis of the rotational position marker 16. If the hammerhead of the hammerhead bolt 7 is not positioned transversely to the anchor rail 1, the reader 13 emits a visual and/or acoustic warning.

In the exemplary embodiment, the hammerhead bolt 7 has, as a rotational position marker 16, two parallel lines on opposite sides of the DMC code applied as an identification code 12 at the hammerhead bolt 7. Other rotational position markers 16 are possible, and the identification code 12 itself can optionally also be used as a rotational position marker 16, provided that the identification code 12 used allows for detecting its rotational position. The rotational position of a DMC code can be detected on the basis of its four corners or on the basis of edge lines.

The quality inspection according to the invention can also be carried out, for example, on a mounting rail rather than on the anchor rail 1 (not shown). A mounting rail is typically also a C-profile rail which, however, is not anchored in an anchor base 2, but is mounted so as to be suspended under a ceiling, for example. A mounting rail is associated with fasteners or so-called suspending brackets, with which the mounting rail is mounted so as to be suspended under the ceiling, hammerhead bolts as components fasteners and attachments as associated components (not shown).

### LIST OF REFERENCE SIGNS

1 Anchor rail
2 Anchor base
3 Visible side
4 Longitudinal slot
5 Base side
6 Anchor
7 Hammerhead bolt
8 Bolt shaft
9 Attachment
10 Component
11 Nut
12 Identification code
13 Reader
14 Database
Component fastener
16 Rotational position marker

1. A method for inspecting the quality of at least one quality criterion of a fastening of an anchor or mounting rail and/or a fastening of an associated component to the anchor or mounting rail, wherein the anchor or mounting rail has an optoelectronically readable identification code on a visible side which is accessible for optoelectronic reading of the identification code when the anchor or mounting rail is fastened as intended, wherein the identification code is read with the aid of an optoelectronic reader and evaluated in terms of the at least one quality criterion, which is also detected optoelectronically.

2. The method according to claim 1, wherein the anchor rail is anchored in an anchor base and has an optoelectronically readable measuring marker on its visible side, with the aid of which the optoelectronic reader detects a position of the anchor rail in the anchor base, and in that the quality criterion is a position criterion for the anchor rail in the anchor base.

3. The method according to claim 1, wherein a component associated with the anchor or mounting rail has an optoelectronically readable identification code which is accessible for optoelectronic reading of the identification code when the anchor rail is anchored in the anchor base as intended and the component associated with the anchor or mounting rail is arranged on or fastened to the anchor or mounting rail as intended, and in that the identification codes are read with the optoelectronic reader and whether the component and the anchor rail belong together is checked by means of the identification codes.

4. The method according to claim 1, wherein the anchor or mounting rail has several optoelectronically readable identification codes and/or optoelectronically readable measurement markers.

5. The method according to claim 1, wherein the component associated with the anchor or mounting rail has an optoelectronically readable rotational position marker, and in that a rotational position of the component arranged on or fastened to the anchor or mounting rail relative to the anchor rail is detected with the optoelectronic reader and is evaluated in terms of at least one quality criterion.

6. The method according to claim 1, wherein a smartphone or tablet computer is used as an optoelectronic reader and a software installed on the optoelectronic reader is used for inspecting the quality.

7. The method according to claim 1, wherein data relating to the anchor or mounting rail and to associated components are stored in a database which is accessed for carrying out the method.
